(19) United States
(12) Patent Application Publication
(10) Pub. No.: US 2025/0021872 A1
(43) Pub. Date: Jan. 16, 2025

(54) DETERMINING DATA QUALITY USING DATA RECONSTRUCTION MODELS

(71) Applicant: Capital One Services, LLC, McLean, VA (US)

(72) Inventors: Samuel SHARPE, Cambridge, MA (US); Brian BARR, Schenectady, NY (US)

(73) Assignee: Capital One Services, LLC, McLean, VA (US)

(21) Appl. No.: 18/352,228

(22) Filed: Jul. 13, 2023

(51) Int. Cl. G06N 20/00

(52) U.S. Cl. CPC G06N 20/00

(57) ABSTRACT

Methods and systems are described herein for determining data quality using data reconstruction models. The system receives a dataset including entries and features and generates a machine learning model for each feature of the dataset. Each model may be trained to generate predictions for a corresponding feature based on other features of the dataset. The system may input, into each model, values of the other features to obtain prediction values for the corresponding feature. For a subset of entries for which a difference between the predicted and actual values of the corresponding feature satisfies a threshold, the system may determine relative impacts of the other features on the corresponding feature. The system may then transmit, to a user, a subset of the other features having relative impacts that meet a feature impact threshold.

### BACKGROUND

Data quality issues, such as abnormal observations within datasets, are often difficult to pinpoint, especially when datasets contain large numbers of features. Determining which features are causing abnormalities may require reviewing each feature individually to determine whether values for that feature fall outside a normal distribution. Furthermore, once erroneous features are identified, the causes behind these errors are difficult to ascertain. For example, an erroneous feature may rely on a number of other features, and any of those other features may be causing a data quality issue. Thus, a mechanism is desired for determining data quality using data reconstruction models.

### SUMMARY

Methods and systems are described herein for determining data quality using data reconstruction models. A model quality system may be built and configured to perform operations discussed herein. The model quality system may receive a dataset with each entry having values for a number of features. For example, the dataset may include applicants to a particular program, and each applicant may be associated with a number of features, such as references, exam scores, grade point averages, applicant attributes, or other features. The model quality system may then generate machine learning models for the features of the dataset. In particular, the model quality system may generate a machine learning model for each feature that is trained to predict values for that feature based on the other features of the dataset. For example, a first model may predict an applicant's references based on exam scores, grade point averages, applicant attributes, or other features, a second model may predict exam scores based on references, grade point averages, applicant attributes, or other features, and so on.

The model quality system may input, into one of these machine learning models associated with a target feature, values of the other features. This may cause the machine learning model to generate predictions for the target feature. For example, the model quality system may input values of references, exam scores, and applicant attributes into a model trained to predict grade point averages. The machine learning model may generate predicted grade point averages, and the model quality system may compare the predicted grade point averages with the observed grade point averages. Some entries may have prediction differences between the predicted grade point averages and the observed grade point averages that exceed a threshold difference. For example, for certain applicants, a difference between the predicted grade point average and the observed grade point average may exceed a threshold. For these entries, the model quality system may obtain feature impact parameters. The feature impact parameters may indicate the impact of the other features on the target feature's prediction values. For example, the feature impact parameters may indicate the impacts of each of references, exam scores, and applicant attributes on the predictions of grade point averages. For features having high enough feature impact parameters with respect to the target feature, the model quality system may determine sources of those features and may transmit a data inspection request to the sources. For example, the feature describing exam scores may have a relative impact on grade point averages that satisfies a threshold, and the model quality system may thus attempt to identify quality issues associated with the source of the exam score data.

In particular, the model quality system may receive a dataset including a plurality of entries, with each entry including corresponding values of a plurality of features. For example, the dataset may include applicants to a particular program, and each applicant may be associated with a number of features, such as references, exam scores, grade point averages, applicant attributes, or other features. In some embodiments, the features may be relied upon to predict admission of the applicants to the program.

The model quality system may generate, for the plurality of features, a plurality of machine learning models. Each machine learning model of the plurality of machine learning models may be trained to generate predictions for a target feature of the plurality of features based on other features of the plurality of features. For example, the model quality system may generate a machine learning model for each feature that is trained to predict values for that feature based on the other features of the dataset. A first model may predict an applicant's references based on exam scores, grade point averages, applicant attributes, or other features, a second model may predict exam scores based on references, grade point averages, applicant attributes, or other features, and so on.

The model quality system may input, into a first machine learning model of the plurality of machine learning models associated with a first target feature of the plurality of features, the plurality of entries with corresponding values of the other features of the dataset to obtain first prediction values for the first target feature. For example, the model quality system may input, into one of these machine learning models associated with a target feature, values of the other features. This may cause the machine learning model to generate predictions for the target feature. For example, the model quality system may input values of references, exam scores, and applicant attributes into a model trained to predict grade point averages. The machine learning model may then generate predicted grade point averages.

The model quality system may determine first prediction differences between the first prediction values and first observed values for the first target feature within the dataset. For example, the model quality system may compare the predicted grade point averages with the observed grade point averages. Some entries may have prediction differences between the predicted grade point averages and the observed grade point averages that exceed a threshold difference. For example, for certain applicants, a difference between the predicted grade point average and the observed grade point average may exceed a threshold. The model quality system may include these applicants in a subset of applicants.

In some embodiments, the model quality system may determine the subset by determining which features have prediction differences that satisfy the threshold difference at least a threshold number of times. For example, the model quality system may determine a number of entries for which the prediction difference of a given feature satisfies the threshold difference. As an example, the model quality system may determine a number of applicants for which the grade point average predictions based on the other features are vastly erroneous. If the number of applicants meets the required threshold (e.g., based on the size of the dataset), the model quality system may include those applicants having erroneous predictions for grade point average in the subset of applicants. In some embodiments, the model quality system may differentiate between features with data quality errors and features for which an erroneous prediction is an anomaly. For example, the model quality system may distinguish between a data quality error and an anomaly based on a frequency of the first prediction differences satisfying the threshold difference.

For the subset of entries having prediction differences that exceed the difference threshold, the model quality system may determine the relative impact of each other feature in the dataset on the target feature. The model quality system may obtain, from the first machine learning model, a first plurality of feature impact parameters indicating a first plurality of relative impacts of the other features on the first prediction values for the subset of entries for which the first prediction differences satisfy a threshold difference. For example, for applicants having vastly erroneous grade point average predictions, the model quality system may obtain feature impact parameters for the grade point average predictions. The feature impact parameters may indicate the impact of the other features on the target feature's prediction values. For example, the feature impact parameters may indicate the impacts of each of references, exam scores, and applicant attributes on the predictions of grade point averages.

The model quality system may determine a feature impact threshold for assessing which of the other features of the plurality of features contributed to the first prediction values. For example, the feature impact threshold may indicate a percentage, portion, or other cutoff below which a feature is not considered to have impacted a prediction significantly. For example, if a feature (e.g., references) has a feature impact parameter (e.g., for grade point average predictions) that falls below the feature impact threshold, the feature may not be considered to significantly impact the prediction.

The model quality system may determine, for a subset of the other features having relative impacts that meet the feature impact threshold for the first prediction values, one or more sources of the subset of the other features. For example, for a subset of features having high enough relative impacts on the target feature, the model quality system may determine sources of those features. As an example, the feature describing exam scores may have a relative impact on grade point averages that satisfies the feature impact threshold. In some embodiments, the model quality system may generate the subset of features to include features having high enough relative impacts on the target feature at a high enough frequency (e.g., based on the size of the dataset). For example, the model quality system may determine that the exam score feature has a relative impact on grade point averages that satisfies the feature impact threshold for two-thirds of the entries. Using a frequency threshold of 60%, the model quality system may include the exam score feature in the subset. In some embodiments, the model quality system may determine a source of the exam score data. The model quality system may then transmit, to one or more sources of the features in the subset (e.g., to one or more sources of the exam score data), a data inspection request.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for determining data quality using data reconstruction models, in accordance with one or more embodiments.

FIG. 2 illustrates a data structure for input into a machine learning model, in accordance with one or more embodiments.

FIG. 3 illustrates an exemplary machine learning model, in accordance with one or more embodiments.

FIG. 4 illustrates a data structure representing impacts of features on predictions of a target feature, in accordance with one or more embodiments.

FIG. 5 illustrates a data structure representing sources of a subset of features, in accordance with one or more embodiments.

FIG. 6 illustrates a computing device, in accordance with one or more embodiments.

FIG. 7 shows a flowchart of operations for determining data quality using data reconstruction models, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

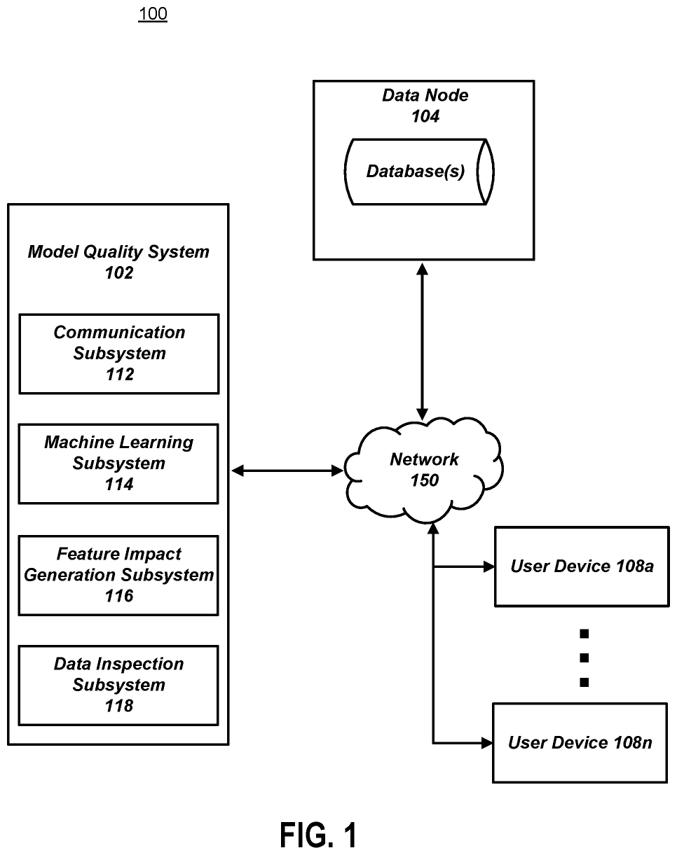

FIG. 1 shows an illustrative system 100 for determining data quality using data reconstruction models, in accordance with one or more embodiments. System 100 may include model quality system 102, data node 104, and user devices 108a-108n. Model quality system 102 may include communication subsystem 112, machine learning subsystem 114, feature impact generation subsystem 116, data inspection subsystem 118, and/or other subsystems. In some embodiments, only one user device may be used while in other embodiments multiple user devices may be used. The user devices 108a-108n may be associated with one or more users. The user devices 108a-108n may be associated with one or more user accounts. In some embodiments, user devices 108a-108n may be computing devices that may receive and send data via network 150. User devices 108a-108n may be end-user computing devices (e.g., desktop computers, laptops, electronic tablets, smartphones, and/or other computing devices used by end users). User devices 108a-108n may output (e.g., via a graphical user interface) run applications, output communications, receive inputs, or perform other actions.

Model quality system 102 may execute instructions for determining data quality using data reconstruction models. Model quality system 102 may include software, hardware, or a combination of the two. For example, communication subsystem 112 may include a network card (e.g., a wireless network card and/or a wired network card) that is associated with software to drive the card. In some embodiments, model quality system 102 may be a physical server or a virtual server that is running on a physical computer system. In some embodiments, model quality system 102 may be configured on a user device (e.g., a laptop computer, a smart phone, a desktop computer, an electronic tablet, or another suitable user device).

Data node 104 may store various data, including one or more machine learning models, training data, communications, and/or other suitable data. In some embodiments, data node 104 may also be used to train machine learning models. Data node 104 may include software, hardware, or a combination of the two. For example, data node 104 may be a physical server, or a virtual server that is running on a physical computer system. In some embodiments, model quality system 102 and data node 104 may reside on the same hardware and/or the same virtual server/computing device. Network 150 may be a local area network, a wide area network (e.g., the Internet), or a combination of the two.

Model quality system 102 (e.g., via communication subsystem 112) may receive a dataset including a plurality of entries with each entry including corresponding values of a plurality of features. For example, the dataset may include applicants to a particular program, and each applicant may be associated with a number of features, such as references, exam scores, grade point averages, applicant attributes, or other features. In some embodiments, the features may be relied upon to predict admission of the applicants to the program.

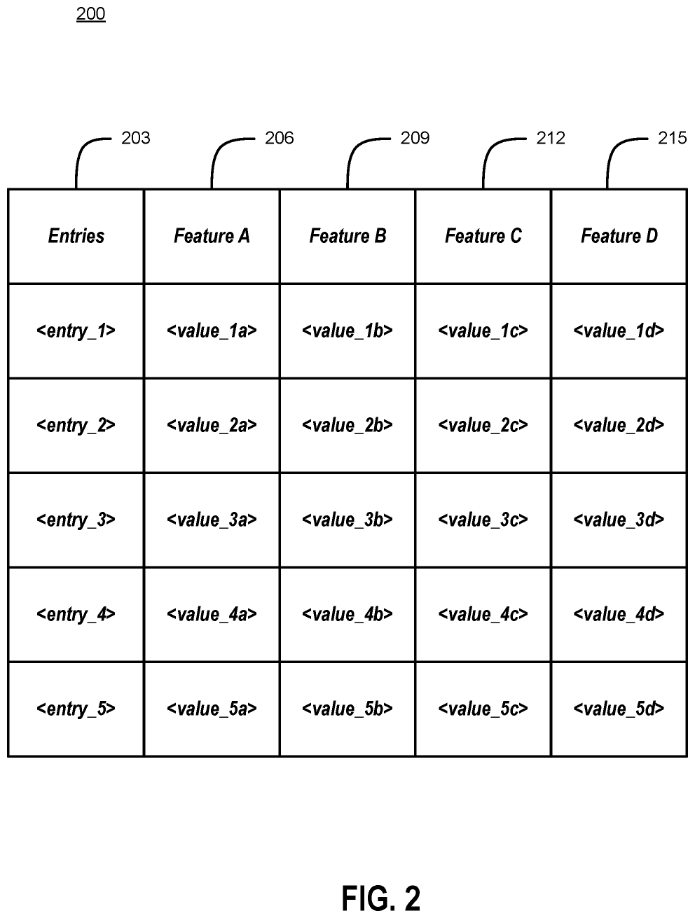

FIG. 2 illustrates a data structure 200 for input into a machine learning model, in accordance with one or more embodiments. In some embodiments, data structure 200 may be a subset of a larger data structure. Data structure 200 may include entries 203, as well as a plurality of features, including feature 206, feature 209, feature 212, and feature 215. Entries 203 may include a plurality of applicants for admission to a particular program. Feature 206 may be references for the applicants, feature 209 may be exam scores associated with the applicants, feature 212 may be grade point averages of the applicants, and feature 215 may be applicant attributes. In some embodiments, data structure 200 may be used to generate predictions for the applicants' admission to the program, for example, by feeding data structure 200 into a machine learning model that is trained to generate predictions for entries 203 (e.g., applicants) based on features 206, 209, 212, and 215 (e.g., references, exam scores, grade point averages, and applicant attributes). In some embodiments, the data quality of data structure 200 may be inspected by reconstructing each feature of features 206, 209, 212, and 215 based on the other features.

Model quality system 102 (e.g., via machine learning subsystem 114) may generate, for the plurality of features, a plurality of machine learning models. Each machine learning model of the plurality of machine learning models may be trained to generate predictions for a target feature of the plurality of features based on other features of the plurality of features. For example, model quality system 102 may generate a machine learning model for each feature that is trained to predict values for that feature based on the other features of the dataset. A first model may predict an applicant's references based on exam scores, grade point averages, applicant attributes, or other features, a second model may predict exam scores based on references, grade point averages, applicant attributes, or other features, and so on.

Model quality system 102 (e.g., via machine learning subsystem 114) may include one or more machine learning models. For example, one or more machine learning models may be trained to generate predictions for entries based on corresponding features. In some embodiments, one or more machine learning models may be trained to generate predictions for each feature based on the other features. Machine learning subsystem 114 may include software components, hardware components, or a combination of both. For example, machine learning subsystem 114 may include software components (e.g., application programming interface (API) calls) that access one or more machine learning models. Machine learning subsystem 114 may access training data, for example, in memory. In some embodiments, machine learning subsystem 114 may access the training data on data node 104 or on user devices 108a-108n. In some embodiments, the training data may include values of the other features and output labels for the target feature. In some embodiments, machine learning subsystem 114 may access one or more machine learning models. For example, machine learning subsystem 114 may access the machine learning models on data node 104 or on user devices 108a-108n.

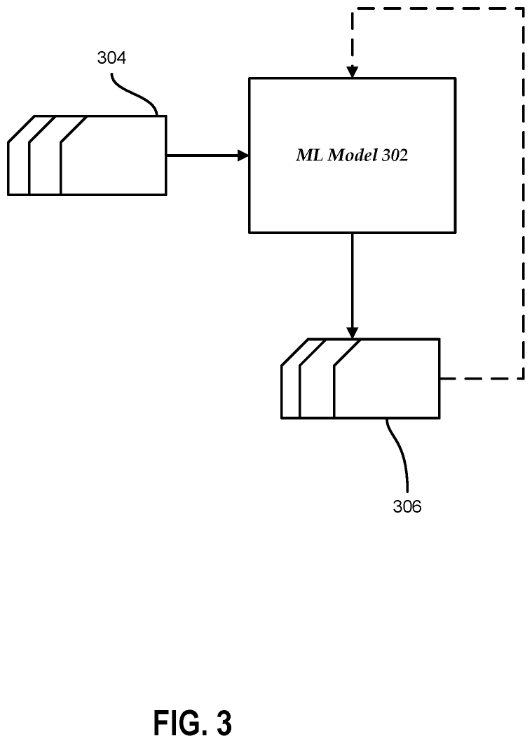

FIG. 3 illustrates an exemplary machine learning model 302, in accordance with one or more embodiments. In some embodiments, machine learning model 302 may be included in machine learning subsystem 114 or may be associated with machine learning subsystem 114. In some embodiments, machine learning subsystem 114 may include a plurality of machine learning models, such as that shown in machine learning model 302. Each machine learning model may have been trained using features associated with entries, such as references, exam scores, grade point averages, applicant attributes, or other features associated with applicants for admission to a particular program. In some embodiments, each machine learning model may be associated with a particular feature (e.g., target feature) of the dataset. The target feature for a particular machine learning model may be the specific feature that the particular machine learning model aims to predict based on the other features of the dataset. Each machine learning model may have been trained to predict values of the corresponding target feature based on values of the other features of the dataset. For example, a first machine learning model may predict applicants' references based on the applicants' exam scores, grade point averages, and applicant attributes. A second machine learning model may predict applicants' exam scores based on the applicants' references, grade point averages, and applicant attributes, and so on.

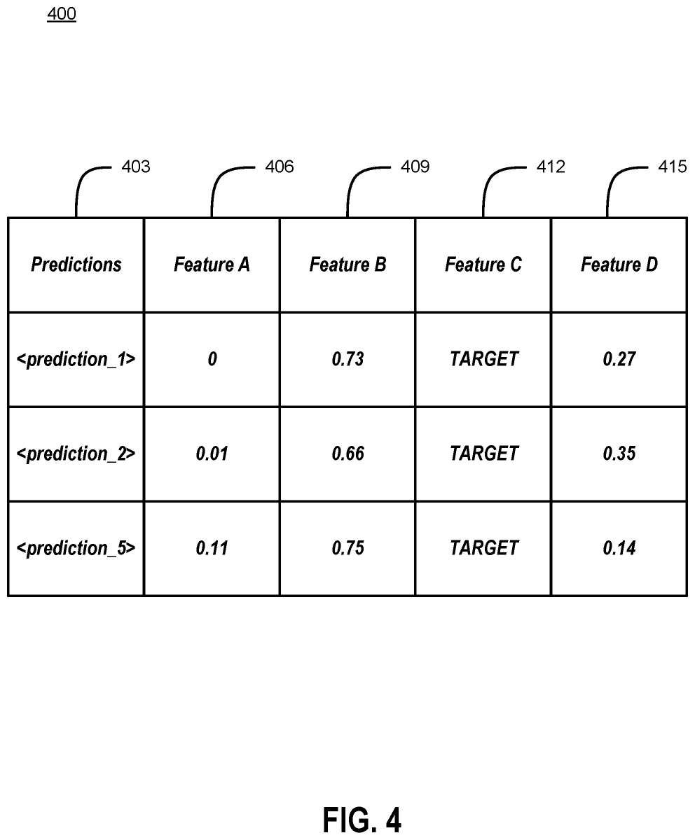

Each machine learning model 302 may take inputs 304 (e.g., values of other features in the dataset) and may generate outputs 306 (e.g., predicted values of the target feature). In some embodiments, the outputs may further include feature impact parameters, as described in greater detail with respect to FIG. 4. The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, each model may function as a data reconstruction model. A data reconstruction model may be an unsupervised neural network that may learn to reconstruct original data. A data reconstruction model may receive input data (e.g., values of a target feature) and progressively reduce the dimensionality of the input, for example, by applying linear transformations, non-linear activation functions, or other functions. The data reconstruction model may then determine, based on the low-dimensional encoding of the input data, important features or patterns in the data while disregarding redundant or less significant information. The data reconstruction model may then aim to reconstruct the original data based on the low-dimensional encoding. Accuracy of the reconstructed data may be assessed using a loss function. The loss function may compare the reconstructed output with the original input and may quantify any discrepancy between them. The data reconstruction model may thus learn a compact and meaningful representation of the input data that captures its essential features. By reconstructing the original data from a compressed representation, the data reconstruction model may uncover patterns, detect anomalies, or reduce noise.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or a supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

Model quality system 102 may input, into a first machine learning model of the plurality of machine learning models, values of the other features of the dataset to obtain first prediction values for a first target feature of the plurality of features. Model quality system 102 may input the dataset into a machine learning model (e.g., machine learning model 302, as shown in FIG. 3) trained to generate predicted values of a target feature based on values of other features. The dataset may include entries with each entry including a number of features. For example, the dataset may include program applicants, and each applicant may be associated with a number of features, such as references, exam scores, grade point averages, applicant attributes, or other features. Model quality system 102 may input values of references, exam scores, and applicant attributes into a model associated with grade point averages. The machine learning model may then generate predicted grade point averages.

Machine learning subsystem 114 may determine first prediction differences between the first prediction values and first observed values for the first target feature within the dataset. Model quality system 102 may compare the predicted grade point averages with the observed grade point averages. Some entries may have prediction differences between the predicted grade point averages and the observed grade point averages that exceed a threshold difference. For example, for certain applicants, a difference between the predicted grade point average and the observed grade point average may exceed a threshold. Model quality system 102 may include these applicants in a subset of applicants.

In some embodiments, machine learning subsystem 114 may determine that the first prediction differences between the first prediction values and the first observed values of the first target feature satisfy the threshold difference at least a threshold number of times. In some embodiments, the threshold number of times may be based on a number of entries within the plurality of entries in the dataset. For example, model quality system 102 may determine a number of entries for which the prediction difference of a given feature satisfies the threshold difference in relation to the total number of entries in the dataset. As an example, model quality system 102 may determine a number of applicants for which the grade point average predictions based on the other features are vastly erroneous. If the number of applicants meets the required threshold (e.g., based on the size of the dataset), model quality system 102 may include those applicants having erroneous predictions for grade point average in the subset of applicants.

In some embodiments, machine learning subsystem 114 may determine, based on a first frequency of the first prediction differences satisfying the threshold difference, whether the first prediction differences indicate an anomaly or a data quality error. For example, model quality system 102 may differentiate between features with data quality errors and features for which an erroneous prediction is an anomaly. Model quality system 102 may distinguish between a data quality error and an anomaly based on a frequency of the first prediction differences satisfying the threshold difference. For example, an anomaly may be identified based on a low frequency of the first prediction differences satisfying the threshold difference. A data quality error may be identified based on a high frequency of the first prediction differences satisfying the threshold difference. In some embodiments, the subset of the other features may be transmitted to the user in response to determining that the first prediction differences indicate a data quality error as opposed to an anomaly.

In some embodiments, each feature in the dataset may be categorical or numerical. Numerical features may include data that is continuous (e.g., a number or amount). For example, a feature indicating grade point averages is numerical (e.g., 0 through 4.0). For a target feature that is numerical, machine learning subsystem 114 may determine the first prediction differences by calculating a difference between predicted and actual values, for example, by subtracting the values. In contrast, categorical features may include data that is separated into categories (e.g., yes or no, 0 or 1, etc.). For example, a feature indicating an applicant attribute such as state of residence may be categorical (e.g., New York, Rhode Island, etc.). For a target feature that is categorical, machine learning subsystem 114 may determine the first prediction differences by performing a logarithmic loss calculation on the prediction values and the observed values. Machine learning subsystem 114 may use a logarithmic loss calculation to penalize larger differences between the predicted and observed values more heavily. For example, the logarithm function may grow slowly for values close to 1 and may approach negative infinity for values close to 0. In some embodiments, a lower logarithmic loss value may indicate that the predicted values are closer to the observed values, while a higher logarithmic loss value may suggest a larger discrepancy between the predicted and observed values.

Model quality system 102 (e.g., via feature impact generation subsystem 116) may determine, for the subset of entries having prediction differences that exceed the difference threshold, the relative impact of each other feature in the dataset on the target feature. For example, feature impact generation subsystem 116 may obtain, from the first machine learning model, a first plurality of feature impact parameters indicating a first plurality of relative impacts of the other features on the first prediction values for a subset of entries for which first prediction differences between the first prediction values and first observed values for the first target feature satisfy a threshold difference. In some embodiments, feature impact parameters may be a metric for indicating a relative impact of each other feature of the dataset on each target feature. For example, for applicants having vastly erroneous grade point average predictions, model quality system 102 may obtain feature impact parameters for the grade point average predictions. The feature impact parameters may indicate the impact of the other features on the target feature's prediction values. For example, the feature impact parameters may indicate the impacts of each of references, exam scores, and applicant attributes on the predictions of grade point averages.

Feature impact generation subsystem 116 may use a number of techniques to obtain the feature impact parameters. As an example, feature impact generation subsystem 116 may use a local linear model, where coefficients determine the estimated impact of each feature. If a feature coefficient is non-zero, then feature impact generation subsystem 116 may determine the feature impact parameter of the feature according to the sign and magnitude of the coefficient. As another example, feature impact generation subsystem 116 may perturb the input around a feature's neighborhood and assess how the machine learning model's predictions behave. Feature impact generation subsystem 116 may then weigh these perturbed data points by their proximity to the original example and learn an interpretable model on those and the associated predictions. As another example, feature impact generation subsystem 116 may randomly generate features surrounding a particular target feature. Feature impact generation subsystem 116 may then use the machine learning model to generate predictions of the generated random features. Feature impact generation subsystem 116 may then construct a local regression model using the generated random features and their generated predictions from the machine learning model. Finally, the coefficients of the regression model may indicate the contribution of each feature to the prediction of the particular feature according to the machine learning model. In some embodiments, feature impact generation subsystem 116 may use these or other techniques to generate the feature impact parameters for the target features based on the other features.

FIG. 4 illustrates a data structure 400 representing impacts of features on predictions of a target feature, in accordance with one or more embodiments. In some embodiments, data structure 400 may be a subset of a larger data structure. Data structure 400 may include predictions 403, as well as feature 406, feature 409, feature 412, and feature 415. In some embodiments, predictions 403 may correspond to entries 203, as shown in FIG. 2. In some embodiments, feature 406, feature 409, feature 412, and feature 415 may correspond to feature 206, feature 209, feature 212, and feature 215, respectively, as shown in FIG. 2. Features 406 may be references, feature 409 may be exam scores, feature 412 may be grade point averages, and feature 415 may be applicant attributes. As shown in FIG. 4, feature 412 (e.g., grade point averages) may be illustrated as a target feature. In some embodiments, data structure 400 may include a subset of the entries of data structure 200, as shown in FIG. 2. For example, data structure 400 may include a subset of entries for which first prediction differences between the first prediction values and first observed values for the first target feature satisfy a threshold difference. For feature 412 as the target feature, data structure 400 may include entries for which a difference between predicted values of feature 412 and observed values of feature 412 satisfy a threshold difference. As such, data structure 400 may include entries for which the predicted grade point averages were most erroneous.

In some embodiments, data structure 400 may illustrate feature impact parameters of each of feature 406, feature 409, and feature 415 on feature 412. For example, the values shown in data structure 400 may represent a relative impact of a given other feature (e.g., feature 406, feature 409, and feature 415) on feature 412. As an example, for a first applicant, feature 406 (e.g., references) may have had no relative impact on feature 412 (e.g., grade point averages), feature 409 (e.g., exam scores) may have had 73% of the impact on feature 412, and feature 415 (e.g., applicant attributes) may have had 27% of the impact on feature 412.

In some embodiments, model quality system 102 may determine a feature impact threshold for assessing which features have contributed to each prediction. For example, the feature impact threshold may be a level below which the other features are not considered to have impacted the target feature. For example, the threshold may indicate a percentage, portion, or other cutoff below which a feature is not considered to have impacted a prediction significantly. For example, if a feature (e.g., references) has a feature impact parameter that falls below the threshold, the feature may not be considered to significantly impact the target feature. In some embodiments, the feature impact threshold may be set to zero, such that any feature having a feature impact parameter above zero for a particular target feature is considered to impact the prediction. In some embodiments, the feature impact threshold may be predetermined or entered manually at a particular level. For example, a higher feature impact threshold (e.g., 0.6) limits the number of features that are considered to impact target features, whereas a lower feature impact threshold (0.4) expands the number of features that are considered to impact target features. If a feature (e.g., references) has a feature impact parameter (e.g., for grade point average predictions) that falls below the feature impact threshold, the feature may not be considered to significantly impact the prediction. In some embodiments, feature impact generation subsystem 116 may include a subset of the other features that are considered to significantly impact the prediction in a subset of other features.

For example, feature impact generation subsystem 116 may determine that the feature impact threshold is 0.6. Accordingly, feature impact generation subsystem 116 may determine that for each student represented in data structure 400, feature 409 (e.g., exam scores) satisfies the feature impact threshold, whereas feature 406 (e.g., references) and feature 415 (e.g., applicant attributes) do not satisfy the feature impact threshold. In some embodiments, feature impact generation subsystem 116 may determine that the feature impact threshold is 0.25. Accordingly, feature impact generation subsystem 116 may determine that for each student represented in data structure 400, feature 409 (e.g., exam scores) satisfies the feature impact threshold and that for two-thirds of the students represented in data structure 400, feature 415 (e.g., applicant attributes) satisfies the feature impact threshold. Feature impact generation subsystem 116 may determine that feature 406 (e.g., references) does not satisfy the feature impact threshold for any of the students represented in data structure 400.

Feature impact generation subsystem 116 may calculate a plurality of frequencies at which the other features have relative impacts that meet the feature impact threshold for the first prediction values. For example, feature impact generation subsystem 116 may determine, across the entries in a dataset, how frequently each other feature has a relative impact that meets the feature impact threshold for the target feature. In some embodiments, frequency may be relative to other features in the dataset or may be measured by count, percentage, rate, or other measurement. One of the other features may have a relative impact that meets the feature impact threshold only 2% of the time while another one of the other features may have a relative impact that meets the feature impact threshold 90% of the time. Feature impact generation subsystem 116 may compare the plurality of frequencies with a frequency threshold. The frequency threshold may be a count, percentage, rate, or other measurement that represents a minimum frequency that other features' relative impacts must meet. Feature impact generation subsystem 116 may then generate the subset of the other features to include the other features for which corresponding frequencies satisfy the frequency threshold. For example, the frequency threshold may be 90% and only other features having relative impacts that meet the feature impact threshold at least 90% of the time (e.g., within the dataset) will be included in the dataset.

For example, feature impact generation subsystem 116 may determine, across the entries in data structure 400, how frequently each other feature has a relative impact that meets a feature impact threshold for the target feature (e.g., feature 412). For example, with a feature impact threshold of 0.25, feature 406 (e.g., references) meets the feature impact threshold for 0% of entries, feature 409 (e.g., exam scores) meets the feature impact threshold for 100% of entries, and feature 415 (e.g., applicant attributes) meets the feature impact threshold for 66.7% of entries. Feature impact generation subsystem 116 may compare these frequencies to a threshold. For example, the frequency threshold may be 66.7%. Accordingly, feature 409 and feature 415 may satisfy the frequency threshold. Feature impact generation subsystem 116 may thus include feature 409 and feature 415 in the subset of the other features.

In some embodiments, feature impact generation subsystem 116 may calculate values of the relative impacts of the other features for the first prediction values. For example, feature impact generation subsystem 116 may calculate the relative impacts of references, exam scores, and applicant attributes on grade point averages across the dataset. Feature impact generation subsystem 116 may then aggregate the values of the relative impacts for each other feature of the other features. Feature impact generation subsystem 116 may aggregate the values of relative impact of feature 406 (e.g., references) on feature 412 (e.g., grade point averages). Feature impact generation subsystem 116 may then aggregate the values of relative impact of feature 409 (e.g., exam scores) on feature 412 (e.g., grade point averages). Feature impact generation subsystem 116 may then aggregate the values of relative impact of feature 415 (e.g., applicant attributes) on feature 412 (e.g., grade point averages). In some embodiments, feature impact generation subsystem 116 may divide the aggregated values by the number of entries in the dataset (e.g., to obtain an average relative impact for each other feature in the dataset). Feature impact generation subsystem 116 may compare the aggregated values for each other feature of the other features with a relative impact threshold. The relative impact threshold may be a minimum aggregated relative impact. The relative impact threshold may be represented by a numerical value, percentage, decimal, or other value. As an example, feature impact generation subsystem 116 may compare the aggregated relative impacts of references on grade point averages with the relative impact threshold, compare the aggregated relative impacts of exam scores on grade point averages with the relative impact threshold, and compare the aggregated relative impacts of applicant attributes on grade point averages with the relative impact threshold. Feature impact generation subsystem 116 may then generate the subset of the other features to include the other features for which corresponding aggregated values satisfy the relative impact threshold. For example, if the aggregated relative impacts of exam scores on grade point averages satisfy the relative impact threshold but the aggregated relative impacts of applicant attributes on grade point averages do not satisfy the relative impact threshold, feature impact generation subsystem 116 may generate the subset of the other features to include exam scores but not applicant attributes.

Model quality system 102 (e.g., via data inspection subsystem 118) may determine, for a subset of the other features having relative impacts that meet the feature impact threshold for the first prediction values, one or more sources of the subset of the other features. For example, for a subset of features having high enough relative impacts on the target feature, model quality system 102 may determine sources of those features. As an example, the feature describing exam scores may have a relative impact on grade point averages that satisfies the feature impact threshold. In some embodiments, model quality system 102 may determine a source of the exam score data. Model quality system 102 may then transmit, to one or more sources of the features in the subset, a data inspection request.

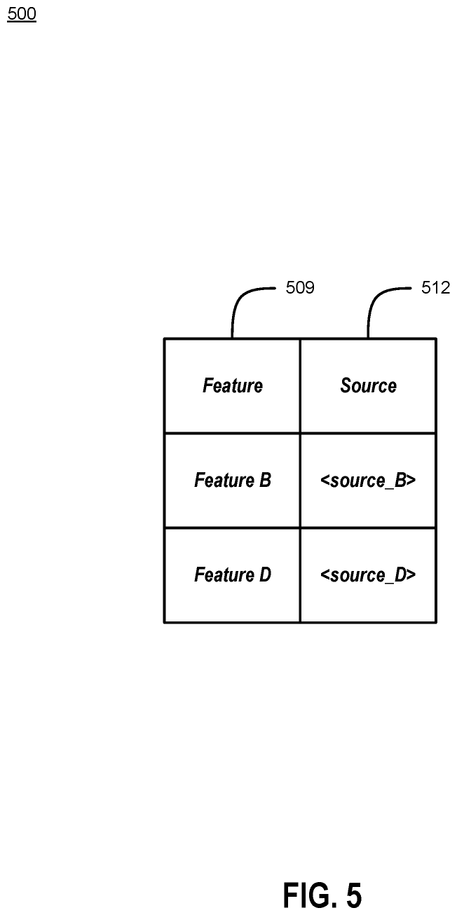

FIG. 5 illustrates a data structure 500 representing sources of a subset of features, in accordance with one or more embodiments. In some embodiments, data structure 500 may be a subset of a larger data structure. In some embodiments, data structure 500 may include features 509 and sources 512 associated with the features. In some embodiments, sources 512 may store identifiers in the form of pointers, codes, file paths, addresses, or other source identifiers.

In some embodiments, to determine the sources of the features, data inspection subsystem 118 may access a code associated with the first target feature identifying the one or more sources. In some embodiments, data inspection subsystem 118 may access a data structure such as data structure 500, as shown in FIG. 5. In some embodiments, data inspection subsystem 118 may access sources 512 to retrieve a code associated with the first target feature. For example, the code may be a file input/output code, a database query code, an API code, a network communication code, or another code identifying a source of data for a feature. Data inspection subsystem 118 may compare the code with one or more source identifiers associated with the first target feature. For example, the source identifiers may identify the correct sources of data for the first target feature. For a feature describing exam scores, a source identifier may identify an exam score database for a particular school. Data inspection subsystem 118 may then determine whether the code contains a valid source identifier of the one or more source identifiers. For example, data inspection subsystem 118 may determine whether the code identifies the exam score database for the particular school. Based on the code lacking a valid source identifier of the one or more source identifiers, data inspection subsystem 118 may determine that a source of the one or more sources is invalid. For example, if the code does not identify the exam score database for the particular school, data inspection subsystem 118 may determine that the source is invalid. Data inspection subsystem 118 may generate an alert indicating that the code includes an invalid source. Communication subsystem 112 may then transmit the alert to the user. In some embodiments, data inspection subsystem 118 may modify the code to remove the invalid source and include the valid source identifier. For example, data inspection subsystem 118 may remove one or more invalid source identifiers from the code and may add one or more valid source identifiers (e.g., the exam score database) to the code.

In some embodiments, model quality system 102 may perform the methods and systems discussed herein with respect to a new plurality of feature impact parameters. In some embodiments, the new plurality of feature impact parameters may indicate contributions of features to error in a predicted target feature, whereas the original plurality of feature impact parameters indicated contributions of features to the predicted target feature values. For example, feature impact generation subsystem 116 may obtain, from the first machine learning model, a new plurality of feature impact parameters indicating a new plurality of relative impacts of the other features on the first prediction differences. In some embodiments, the new feature impact parameters may indicate the impact of each other feature on the error in the predicted values of the target feature, as opposed to the impact of each other feature on the predictions of the values of the target feature. For example, feature impact generation subsystem 116 may obtain new feature impact parameters indicating the impact of each of references, exam scores, and applicant attributes on the error in the predicted grade point averages. Feature impact generation subsystem 116 may determine a new feature impact threshold for assessing which of the other features of the plurality of features contributed to the error in the predicted values of the target feature. In some embodiments, communication subsystem 112 may transmit, to the user, a new subset of the other features having relative impacts that meet the new feature impact threshold for the first prediction differences.

### Computing Environment

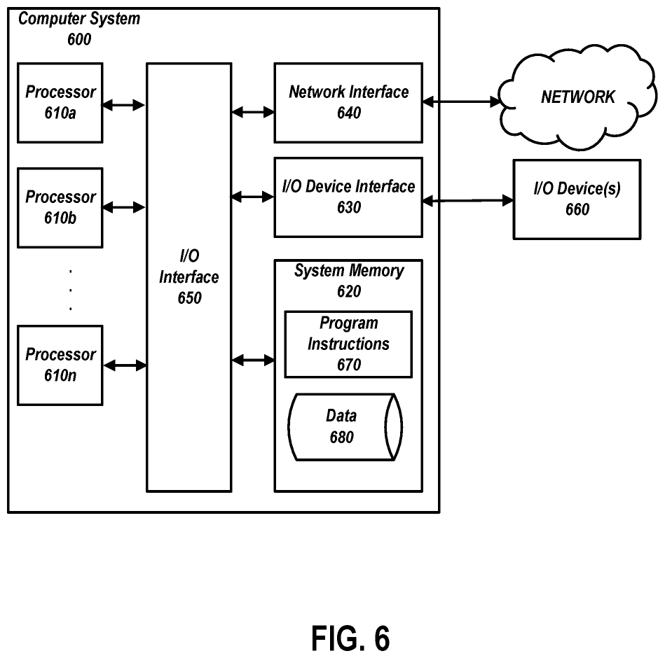

FIG. 6 shows an example computing system 600 that may be used in accordance with some embodiments of this disclosure. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, for example., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computing system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computing system 600 through a wired or wireless connection. I/O devices 660 may be connected to computing system 600 from a remote location. I/O devices 660 located on remote computer systems, for example, may be connected to computing system 600 via a network and network interface 640.

Network interface 640 may include a network adapter that provides for connection of computing system 600 to a network. Network interface 640 may facilitate data exchange between computing system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 600, or multiple computer systems 600 configured to host different portions or instances of embodiments. Multiple computer systems 600 may provide for parallel or sequential processing/execution of one or more portions of the techniques described herein.

Those skilled in the art will appreciate that computing system 600 is merely illustrative, and is not intended to limit the scope of the techniques described herein. Computing system 600 may include any combination of devices or software that may perform or otherwise provide for the performance of the techniques described herein. For example, computing system 600 may include or be a combination of a cloud-computing system, a data center, a server rack, a server, a virtual server, a desktop computer, a laptop computer, a tablet computer, a server device, a user device, a mobile telephone, a personal digital assistant (PDA), a mobile audio or video player, a game console, a vehicle-mounted computer, a Global Positioning System (GPS), or the like. Computing system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

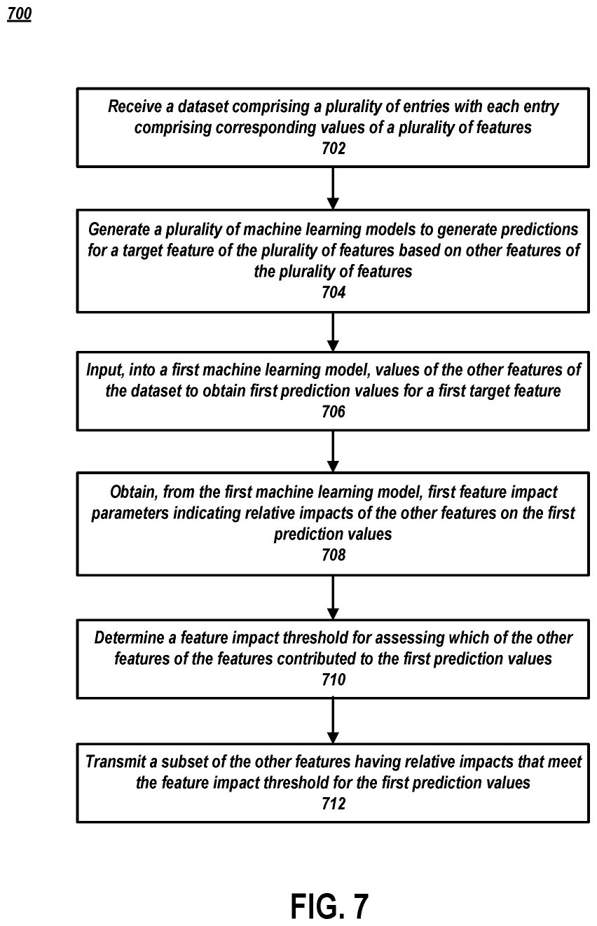

FIG. 7 shows a flowchart of operations 700 for determining data quality using data reconstruction models, in accordance with one or more embodiments. For example, the system may use operations 700 (e.g., as implemented on one or more system components described above) to determine sources of features contributing to data quality errors.

At 702, model quality system 102 (e.g., using one or more of processors 610a-610n) may receive a dataset including a plurality of entries with each entry including corresponding values of a plurality of features. Model quality system 102 may receive the dataset from system memory 620, via the network, or elsewhere.

At 704, model quality system 102 (e.g., using one or more of processors 610a-610n) may generate a plurality of machine learning models to generate predictions for a target feature of the plurality of features based on other features of the plurality of features. In some embodiments, model quality system 102 may generate the predictions using one or more of processors 610a-610n.

At 706, model quality system 102 (e.g., using one or more of processors 610a-610n) may input, into a first machine learning model, values of the other features of the dataset to obtain first prediction values for a first target feature. Model quality system 102 may input the values into the machine learning model using one or more of processors 610a-610n.

At 708, model quality system 102 (e.g., using one or more of processors 610a-610n) may obtain, from the first machine learning model, first feature impact parameters indicating relative impacts of the other features on the first prediction values. Model quality system 102 may obtain the first feature impact parameters using one or more of processors 610a-610n.

At 710, model quality system 102 (e.g., using one or more of processors 610a-610n) may determine a feature impact threshold for assessing which of the other features contributed to the first prediction values. In some embodiments, model quality system 102 may determine the feature impact threshold using one or more of processors 610a-610n.

At 712, model quality system 102 (e.g., using one or more of processors 610a-610n) may transmit a subset of the other features having relative impacts that meet the feature impact threshold for the first prediction values. In some embodiments, model quality system 102 may transmit the subset of the other features using one or more of processors 610a-610n.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 7.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising receiving a dataset comprising a plurality of entries with each entry comprising corresponding values of a plurality of features, generating, for the plurality of features, a plurality of machine learning models, wherein each machine learning model of the plurality of machine learning models is trained to generate predictions for a target feature of the plurality of features based on other features of the plurality of features, inputting, into a first machine learning model of the plurality of machine learning models, values of the other features of the dataset to obtain first prediction values for a first target feature of the plurality of features, obtaining, from the first machine learning model, a first plurality of feature impact parameters indicating a first plurality of relative impacts of the other features on the first prediction values for a subset of entries for which first prediction differences between the first prediction values and first observed values for the first target feature satisfy a threshold difference, determining a feature impact threshold for assessing which of the other features of the plurality of features contributed to the first prediction values, and transmitting, to a user, a subset of the other features having relative impacts that meet the feature impact threshold for the first prediction values.
2. The method of any one of the preceding embodiments, further comprising determining that the first prediction differences between the first prediction values and the first observed values of the first target feature satisfy the threshold difference at least a threshold number of times.
3. The method of any one of the preceding embodiments, wherein the threshold number of times is based on a number of entries within the plurality of entries in the dataset.
4. The method of any one of the preceding embodiments, further comprising determining, based on a first frequency of the first prediction differences satisfying the threshold difference, whether the first prediction differences indicate an anomaly or a data quality error, wherein the subset of the other features is transmitted to the user in response to determining that the first prediction differences indicate the data quality error.
5. The method of any one of the preceding embodiments, further comprising calculating a plurality of frequencies at which the other features have the relative impacts that meet the feature impact threshold for the first prediction values, comparing the plurality of frequencies with a frequency threshold, and generating the subset of the other features comprising the other features for which corresponding frequencies satisfy the frequency threshold.
6. The method of any one of the preceding embodiments, further comprising determining that one or more subsets of the plurality of subsets of the dataset have similar sparsity metrics to one or more other subsets of the plurality of subsets of the dataset, and training a new machine learning model based on the one or more subsets and the one or more other subsets.
7. The method of any one of the preceding embodiments, further comprising determining, for the subset of the other features having the relative impacts that meet the feature impact threshold for the first prediction values, one or more sources of the subset of the other features, and transmitting, to the one or more sources, a data inspection request.
8. The method of any one of the preceding embodiments, wherein determining the one or more sources comprises accessing a code associated with the first target feature identifying the one or more sources, comparing the code with one or more source identifiers associated with the first target feature, determining, based on the code lacking a valid source identifier of the one or more source identifiers, that a source of the one or more sources is invalid, generating an alert indicating that the code comprises an invalid source, and transmitting the alert to the user.
9. The method of any one of the preceding embodiments, further comprising modifying the code to remove the invalid source and include the valid source identifier.
10. The method of any one of the preceding embodiments, further comprising obtaining, from the first machine learning model, a new plurality of feature impact parameters indicating a new plurality of relative impacts of the other features on the first prediction differences.
11. The method of any one of the preceding embodiments, further comprising determining a new feature impact threshold for assessing which of the other features of the plurality of features contributed to the first prediction differences, and transmitting, to the user, a new subset of the other features having relative impacts that meet the new feature impact threshold for the first prediction differences.
12. The method of any one of the preceding embodiments, wherein the first target feature is categorical, further comprising determining the first prediction differences by performing a logarithmic loss calculation on the first prediction values received from the first machine learning model for the first target feature and the first observed values for the first target feature.
13. A tangible, non-transitory, machine-readable medium storing instructions that, when executed by a data processing apparatus, cause the data processing apparatus to perform operations comprising those of any of embodiments 1-12.
14. A system comprising one or more processors; and memory storing instructions that, when executed by the processors, cause the processors to effectuate operations comprising those of any of embodiments 1-12.
15. A system comprising means for performing any of embodiments 1-12.
16. A system comprising cloud-based circuitry for performing any of embodiments 1-12.

What is claimed is:

1. A system for determining data quality using data reconstruction models, the system comprising:
one or more processors, at least one memory, and one or more computer-readable media having computer-executable instructions stored thereon, the computer-executable instructions, when executed by the one or more processors, causing the system to perform operations comprising:
receiving a dataset comprising a plurality of entries with each entry comprising corresponding values of a plurality of features;
generating, for the plurality of features, a plurality of machine learning models, wherein each machine learning model of the plurality of machine learning models is trained to generate predictions for a target feature of the plurality of features based on other features of the plurality of features;
inputting, into a first machine learning model of the plurality of machine learning models associated with a first target feature of the plurality of features, the plurality of entries with corresponding values of the other features of the dataset to obtain first prediction values for the first target feature;
determining first prediction differences between the first prediction values and first observed values for the first target feature within the dataset;
obtaining, from the first machine learning model, a first plurality of feature impact parameters indicating a first plurality of relative impacts of the other features on the first prediction values for a subset of entries for which the first prediction differences satisfy a threshold difference;
determining a feature impact threshold for assessing which of the other features of the plurality of features contributed to the first prediction values;
determining, for a subset of the other features having relative impacts that meet the feature impact threshold for the first prediction values, one or more sources of the subset of the other features; and
transmitting, to the one or more sources, a data inspection request.

2. A method comprising:
receiving a dataset comprising a plurality of entries with each entry comprising corresponding values of a plurality of features;
generating, for the plurality of features, a plurality of machine learning models, wherein each machine learning model of the plurality of machine learning models is trained to generate predictions for a target feature of the plurality of features based on other features of the plurality of features;
inputting, into a first machine learning model of the plurality of machine learning models, values of the other features of the dataset to obtain first prediction values for a first target feature of the plurality of features;
obtaining, from the first machine learning model, a first plurality of feature impact parameters indicating a first plurality of relative impacts of the other features on the first prediction values for a subset of entries for which first prediction differences between the first prediction values and first observed values for the first target feature satisfy a threshold difference;
determining a feature impact threshold for assessing which of the other features of the plurality of features contributed to the first prediction values; and
transmitting, to a user, a subset of the other features having relative impacts that meet the feature impact threshold for the first prediction values.

3. The method of claim 2, further comprising determining that the first prediction differences between the first prediction values and the first observed values of the first target feature satisfy the threshold difference at least a threshold number of times.

4. The method of claim 3, wherein the threshold number of times is based on a number of entries within the plurality of entries in the dataset.

5. The method of claim 3, further comprising:
determining, based on a first frequency of the first prediction differences satisfying the threshold difference, whether the first prediction differences indicate an anomaly or a data quality error,
wherein the subset of the other features is transmitted to the user in response to determining that the first prediction differences indicate the data quality error.

6. The method of claim 2, further comprising:
calculating a plurality of frequencies at which the other features have the relative impacts that meet the feature impact threshold for the first prediction values;
comparing the plurality of frequencies with a frequency threshold; and
generating the subset of the other features comprising the other features for which corresponding frequencies satisfy the frequency threshold.

7. The method of claim 2, further comprising:
calculating values of the relative impacts of the other features for the first prediction values;
aggregating the values of the relative impacts for each other feature of the other features;
comparing the aggregated values for each other feature of the other features with a relative impact threshold; and
generating the subset of the other features comprising the other features for which corresponding aggregated values satisfy the relative impact threshold.

8. The method of claim 2, further comprising:
determining, for the subset of the other features having the relative impacts that meet the feature impact threshold for the first prediction values, one or more sources of the subset of the other features; and
transmitting, to the one or more sources, a data inspection request.

9. The method of claim 8, wherein determining the one or more sources comprises:
accessing a code associated with the first target feature identifying the one or more sources;
comparing the code with one or more source identifiers associated with the first target feature;
determining, based on the code lacking a valid source identifier of the one or more source identifiers, that a source of the one or more sources is invalid;
generating an alert indicating that the code comprises an invalid source; and
transmitting the alert to the user.

10. The method of claim 9, further comprising modifying the code to remove the invalid source and include the valid source identifier.

11. The method of claim 2, further comprising obtaining, from the first machine learning model, a new plurality of feature impact parameters indicating a new plurality of relative impacts of the other features on the first prediction differences.

12. The method of claim 11, further comprising:
determining a new feature impact threshold for assessing which of the other features of the plurality of features contributed to the first prediction differences; and
transmitting, to the user, a new subset of the other features having relative impacts that meet the new feature impact threshold for the first prediction differences.

13. The method of claim 2, wherein the first target feature is categorical, further comprising determining the first prediction differences by performing a logarithmic loss calculation on the first prediction values received from the first machine learning model for the first target feature and the first observed values for the first target feature.

14. One or more non-transitory, computer-readable media storing instructions that when executed by one or more processors, cause operations comprising:
receiving a dataset comprising a plurality of entries with each entry comprising corresponding values of a plurality of features;
generating, for each feature of the plurality of features, a plurality of machine learning models, wherein each machine learning model of the plurality of machine learning models is trained to generate predictions for a target feature of the plurality of features based on other features of the plurality of features;
inputting, into a first machine learning model of the plurality of machine learning models, values of the other features of the dataset to obtain first prediction values for a first target feature of the plurality of features;
obtaining, from the first machine learning model, a first plurality of feature impact parameters indicating a first plurality of relative impacts of the other features on the first prediction values for a subset of entries for which first prediction differences between the first prediction values and first observed values for the first target feature satisfy a threshold difference;
determining a feature impact threshold for assessing which of the other features of the plurality of features contributed to the first prediction values; and
transmitting, to a user, a subset of the other features having relative impacts that meet the feature impact threshold for the first prediction values.

15. The one or more non-transitory, computer-readable media of claim 14, wherein the instructions further cause the one or more processors to perform operations comprising determining that the first prediction differences between the first prediction values and the first observed values of the first target feature satisfy the threshold difference at least a threshold number of times.

16. The one or more non-transitory, computer-readable media of claim 15, wherein the threshold number of times is based on a number of entries within the plurality of entries in the dataset.

17. The one or more non-transitory, computer-readable media of claim 15, wherein the instructions further cause the one or more processors to perform operations comprising:
determining, based on a first frequency of the first prediction differences satisfying the threshold difference, whether the first prediction differences indicate an anomaly or a data quality error,
wherein the subset of the other features is transmitted to the user in response to determining that the first prediction differences indicate the data quality error.

18. The one or more non-transitory, computer-readable media of claim 14, wherein the instructions further cause the one or more processors to perform operations comprising:
calculating a plurality of frequencies at which the other features have the relative impacts that meet the feature impact threshold for the first prediction values;
comparing the plurality of frequencies with a frequency threshold; and
generating the subset of the other features comprising the other features for which corresponding frequencies satisfy the frequency threshold.

19. The one or more non-transitory, computer-readable media of claim 14, wherein the instructions further cause the one or more processors to perform operations comprising:
calculating values of the relative impacts of the other features for the first prediction values;
aggregating the values of the relative impacts for each other feature of the other features;
comparing the aggregated values for each other feature of the other features with a relative impact threshold; and
generating the subset of the other features comprising the other features for which corresponding aggregated values satisfy the relative impact threshold.

20. The one or more non-transitory, computer-readable media of claim 14, wherein the instructions further cause the one or more processors to perform operations comprising:
determining, for the subset of the other features having the relative impacts that meet the feature impact threshold for the first prediction values, one or more sources of the subset of the other features; and
transmitting, to the one or more sources, a data inspection request.
